(19) United States
(12) Patent Application Publication
(10) Pub. No.: US 2017/0140137 A1
(43) Pub. Date: May 18, 2017

(54) Multi-System Entering Method, Apparatus and Terminal

(71) Applicant: Yulong Computer Telecommunication Scientific (Shenzhen), Co., Ltd., Shenzhen (CN)

(72) Inventor: Yaosheng Mao, Shenzhen (CN)

(21) Appl. No.: 15/416,724

(22) Filed: Jan. 26, 2017

Related U.S. Application Data
(63) Continuation-in-part of application No. PCT/CN2014/096028, filed on Dec. 31, 2014.

(30) Foreign Application Priority Data
Jul. 30, 2014 (CN) 201410371022.9

(51) Int. Cl. G06F 21/31; G06F 21/62

(52) U.S. Cl. CPC G06F 21/31; G06F 21/62

(57) ABSTRACT

A multi-system entering method, a multi-system entering apparatus, and a terminal include: setting unlocking rules of multiple systems; detecting matching conditions between a received unlocking password and the unlocking rules of the multiple systems; and according to the matching conditions between the received unlocking password and the unlocking rules, entering a corresponding system. The method can solve the problem of poor operation experience of a user caused by the method in which only one system can be entered before another system is entered.

### CROSS-REFERENCE TO RELATED APPLICATION(S)

This application is a continuation-in-part of international Patent Application No. PCT/CN2014/096028 filed on Dec. 31, 2014, which claims priority to Chinese Patent Application No. 201410371022.9 filed on Jul. 30, 2014, the contents of both hereby incorporated by reference in their entireties.

### TECHNICAL FIELD

The present disclosure relates to the technical field of terminals, and in particular, to a multi-system entering method, an apparatus and a terminal.

### BACKGROUND

Currently, smart phones are importantly characterized in the use of open operating systems, such as iOS, Android, and so on. On such operating system platforms, many third-party applications can be installed, thereby extending functions of the smart phones. However, it is also easy for viruses and malicious software to intrude, leading to leakage of privacy data of a user, such as calls, messages, contacts, and so on. In order to improve the security of the smart phones, a smart phone with dual operating systems is proposed currently. The smart phone has two operating systems, one operating system being used for handling common affairs and referred to as the common system, the other operating system being used for handling secret or private affairs and referred to as the security system. Naturally, there may be more operating systems in a terminal.

The method of entering multiple systems can be entering the common system at first, then accessing entry of the security system in the common system, performing corresponding unlocking operation, and entering the security system. In such a method of entering multiple systems, every time the common system should be entered at first, and then the security system is entered from the common system, such that the user cannot directly enter the security system to handle emergency affairs, thus impacting operation experience of the user. Moreover, in the previous example, it is impossible to enter the security system at first, and then enter the common system from the security system, such that the user may only enter a terminal system unidirectionally and systems cannot be changed into each other bidirectionally.

### SUMMARY

The present disclosure provides a multi-system entering method, an apparatus and a terminal, in order to solve the problem of poor operation experience of a user caused by the method in which only one system can be entered before another system is entered.

A multi-system entering method is provided and comprises: setting unlocking rules of multiple systems; detecting matching conditions between a received unlocking password and the unlocking rules of the multiple systems; and entering a corresponding system according to the matching conditions between the received unlocking password and the unlocking rules.

Furthermore, setting the unlocking rules of the multiple systems comprises setting unlocking passwords of the multiple systems.

Furthermore, the unlocking passwords of the multiple systems are set different; and entering a corresponding system according to the matching conditions between the received unlocking password and the unlocking rules comprises: when the received unlocking password matches with the unlocking password of one of the systems, entering the system of which the unlocking password is matched with.

Furthermore, the unlocking passwords of the multiple systems are set identical; setting the unlocking rules of the multiple systems further comprises setting unlocking priority levels of the multiple systems; and entering a corresponding system according to the matching conditions between the received unlocking password and the unlocking rules comprises: when the received unlocking password matches with the set unlocking passwords of the multiple systems, entering the system having the highest unlocking priority level.

Furthermore, the unlocking passwords of the multiple systems are set identical; the unlocking priority levels of the multiple systems are not set, and the unlocking priority level of one of the systems are set by default higher than other systems; and entering a corresponding system according to the matching conditions between the received unlocking password and the unlocking rules comprises: when the received unlocking password matches with the set unlocking passwords of the multiple systems, entering the system having the highest unlocking priority level.

Furthermore, the unlocking modes for the multiple systems are set identical, the unlocking modes being inputting a pattern, a password or a gesture for unlocking.

A multi-system entering apparatus is further provided correspondingly and comprises: a storage unit storing a plurality of computer-readable program codes; and a processor electrically connected to the storage unit and configured to execute the plurality of computer-readable program codes to: set unlocking rules of multiple systems; detect matching conditions between a received unlocking password and the unlocking rules of the multiple systems; and enter a corresponding system according to the matching conditions between the received unlocking password and the unlocking rules.

Furthermore, setting the unlocking rules of the multiple systems comprises setting unlocking passwords of the multiple systems.

Furthermore, the unlocking passwords of the multiple systems are set different; and entering a corresponding system according to the matching conditions between the received unlocking password and the unlocking rules comprises: when the received unlocking password matches with the unlocking password of one of the systems, entering the system of which the unlocking password is matched with.

Furthermore, the unlocking passwords of the multiple systems are set identical; setting the unlocking rules of the multiple systems further comprises setting unlocking priority levels of the multiple systems; and entering a corresponding system according to the matching conditions between the received unlocking password and the unlocking rules comprises: when the received unlocking password matches with the set unlocking passwords of the multiple systems, entering the system having the highest unlocking priority level.

Furthermore, the unlocking passwords of the multiple systems are set identical; the unlocking priority levels of the multiple systems are not set, and the unlocking priority level of one of the systems are set by default higher than other systems; and entering a corresponding system according to the matching conditions between the received unlocking password and the unlocking rules comprises: when the received unlocking password matches with the set unlocking passwords of the multiple systems, entering the system having the highest unlocking priority level.

Furthermore, the unlocking modes for the multiple systems are set identical, the unlocking modes being inputting a pattern, a password or a gesture for unlocking.

A terminal having multiple systems is further provided correspondingly and comprises the above-mentioned multi-system entering apparatus.

In the multi-system entering method, apparatus and the terminal provided by the implementation, unlocking rules of multiple systems are set, matching conditions between a received unlocking password and the unlocking rules of the multiple systems are determined, and according to the matching conditions between the received unlocking password and the unlocking rules of the multiple systems, a system of which the set unlocking password is matched with by the received password is entered. Therefore, by means of the multi-system entering method, apparatus and the terminal provided by the implementation, a user can input an unlocking password of a corresponding system in an unlocking interface according to needs and enter the corresponding system, and thus it is convenient for the user to select the system to be entered, thereby improving user experience.

### BRIEF DESCRIPTION OF THE DRAWINGS

FIG. 1 is a flow chart of a multi-system entering method according to an implementation of the present disclosure;

FIG. 2 is a block diagram of a multi-system entering apparatus provided by an implementation of the present disclosure.

FIG. 3 shows a schematic structural diagram of another multi-system entering apparatus according to another implementation of the present disclosure.

### DETAILED DESCRIPTION

The present disclosure is described in detail hereinafter with reference to the accompanying drawings and implementations, in order to further set forth technical solutions adopted by the present disclosure to achieve the intended purpose and effects thereof.

A multi-system entering method according to an implementation of the present disclosure is applied in a terminal having at least two operating systems, for example, a smart phone with dual operating systems. In the implementation, a terminal having two operating systems is described as an example, and the two operating systems are defined as the first system and the second system. Specifically, one of the first and second systems may be a security system, and the other may be a common system.

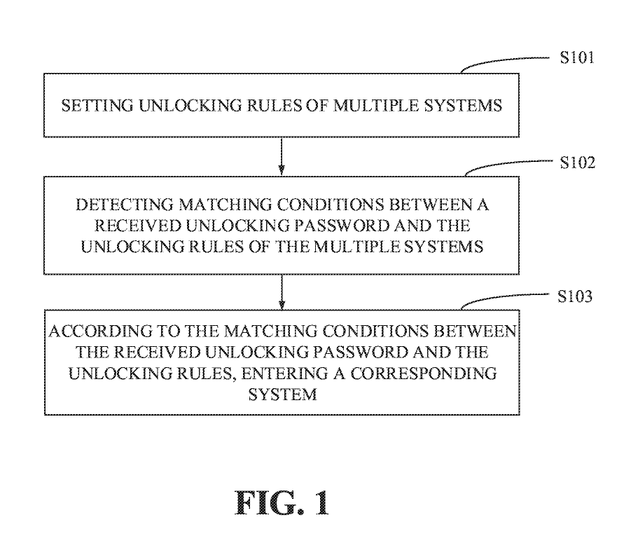

Referring to FIG. 1, a multi-system entering method is provided by a first implementation of the present disclosure, and comprises the following steps:

Step S101: unlocking rules of multiple systems are set.

In this step, different unlocking passwords may be set for the first system and the second system, respectively, according to different unlocking modes. The unlocking modes may be various modes used for unlocking, such as inputting a pattern, a password or a gesture for unlocking. In at least one implementation, the unlocking modes set for the first system and the second system are identical. For example, the unlocking modes set for both the first system and the second system may be inputting a password for unlocking, the unlocking password set for the first system may be 1234, and the unlocking password set for the second system may be 5678. The unlocking rule further comprises setting unlocking priority levels when the identical unlocking passwords are set for both the first system and the second system. For example, the unlocking passwords set for both the first system and the second system may be 1234, and the unlocking priority level of the first system is set higher than that of the second system. In this case, when unlocking, the first system is unlocked at first if the password is input correctly.

It is understood that, when the identical unlocking passwords are set for both the first system and the second system, it is may be determined by default that the unlocking priority level of one of the systems is higher than that of the other, if the unlocking priority levels of the first system and the second system are not set.

Step S102: matching conditions between a received unlocking password and the unlocking rules of the multiple systems are detected.

In the case that different unlocking passwords are set for the first system and the second system, whether a received password matches with the password of the first system or the password of the second system is detected. If the input password is consistent with the unlocking password of one of the systems, it is determined that the received unlocking password matches with the unlocking password of the system.

In the case that the identical unlocking passwords are set for both the first system and the second system, it is determined according to the unlocking priority rule set in Step S101 that a received password matches with the password of the system having a higher unlocking priority level, when the received password is the identical as the set password.

In the case that an unlocking password received from the unlocking interface is different from any one of the unlocking passwords of the two systems, it is determined that the received unlocking password does not match with the unlocking password of each system.

Step S103: a corresponding system is entered according to the matching conditions between the received unlocking password and the unlocking rules.

In the case that different unlocking passwords are set for the first system and the second system, the system of which the set password is matched with by the received password is entered.

In the case that the identical unlocking passwords are set for both the first system and the second system, the system having a higher unlocking priority level is entered.

In the case that an unlocking password received from the unlocking interface does not match with the unlocking password of each system, no system is entered.

In the multi-system entering method provided by the implementation, unlocking rules of multiple systems are set, matching conditions between a received unlocking password and the unlocking rules of the multiple systems are determined, and according to the matching conditions between the received unlocking password and the unlocking rules of the multiple systems, a system of which the set unlocking password is matched with by the received password is entered. Therefore, by means of the multi-system entering method provided by the implementation, a user can input an unlocking password of a corresponding system in an unlocking interface according to needs and enter the corresponding system, and thus it is convenient for the user to select the system to be entered, thereby improving user experience.

Furthermore, the problem where a terminal system may be only entered unidirectionally and systems cannot be changed into each other bidirectionally can be solved.

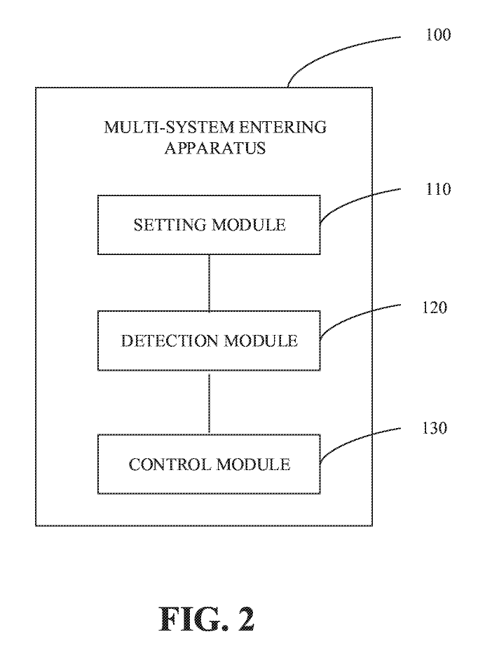

Please referring to FIG. 2, a multi-system entering apparatus 100 is correspondingly provided by the technical solution. The multi-system entering apparatus 100 comprises a setting module 110, a detection module 120 and a control module 130.

The setting module 110 is configured for setting unlocking rules of multiple systems.

In the implementation, the setting module 110 can set different unlocking passwords for the first system and the second system, respectively. The set unlocking rules may include different unlocking modes. The unlocking modes may be various modes used for unlocking, such as inputting a pattern, a password or a gesture for unlocking. In at least one implementation, the unlocking modes set for the first system and the second system are identical. For example, the unlocking modes set for both the first system and the second system may be inputting a password for unlocking, the unlocking password set for the first system may be 1234, and the unlocking password set for the second system may be 5678. The unlocking rule further comprises setting unlocking priority levels when the identical unlocking passwords are set for both the first system and the second system. For example, the unlocking passwords set for both the first system and the second system may be 1234, and the unlocking priority level of the first system is set higher than that of the second system. In this case, when unlocking, the first system is unlocked at first if the password is input correctly.

It is understood that, when the identical unlocking passwords are set for both the first system and the second system, the setting module 110 may determine by default that the unlocking priority level of one of the systems is higher than that of the other, if the unlocking priority levels of the first system and the second system are not set.

The detection module 120 is configured for detecting matching conditions between a received unlocking password and the unlocking rules of the multiple systems.

In the case that different unlocking passwords are set for the first system and the second system, whether a received password matches with the password of the first system or the password of the second system is detected. If the input password is consistent with the unlocking password of one of the systems, the detection module 120 determines that the received unlocking password matches with the unlocking password of the system.

In the case that the identical unlocking passwords are set for both the first system and the second system, the detection module 120 determines according to the set unlocking priority rule that a received password matches with the password of the system having a higher unlocking priority level, when the received password is the identical as the set password.

In the case that an unlocking password received from the unlocking interface is different from any one of the unlocking passwords of the two systems, the detection module 120 determines that the received unlocking password does not match with the unlocking password of each system.

The control module 130 is configured for entering a corresponding system according to the matching conditions between the received unlocking password and the unlocking rules.

In the case that different unlocking passwords are set for the first system and the second system, the control module 130 controls such that the system of which the set password is matched with by the received password is entered.

In the case that the identical unlocking passwords are set for both the first system and the second system, the control module 130 controls such that the system having a higher unlocking priority level is entered.

In the case that an unlocking password received from the unlocking interface does not match with the unlocking password of each system, the control module 130 controls such that no system is entered.

In the multi-system entering apparatus provided by the implementation, unlocking rules of multiple systems are set, matching conditions between a received unlocking password and the unlocking rules of the multiple systems are determined, and according to the matching conditions between the received unlocking password and the unlocking rules of the multiple systems, a system of which the set unlocking password is matched with by the received password is entered. Therefore, by means of the multi-system entering method provided by the implementation, a user can input an unlocking password of a corresponding system in an unlocking interface according to needs and enter the corresponding system, and thus it is convenient for the user to select the system to be entered, thereby improving user experience.

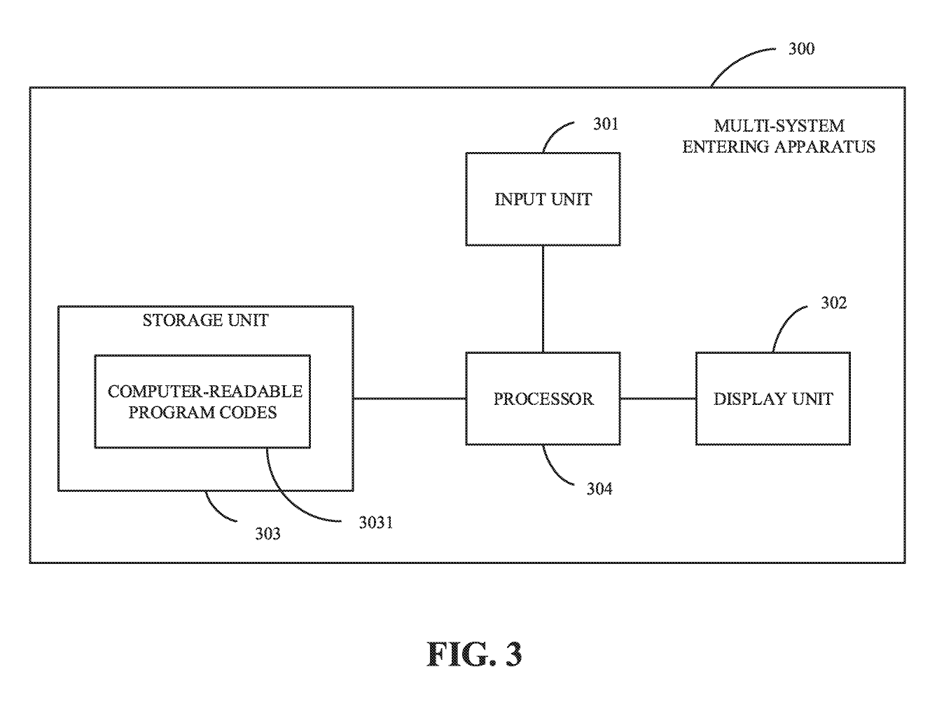

FIG. 3 shows a schematic structural diagram of another multi-system entering apparatus according to another implementation of the present disclosure.

As shown in FIG. 3, another multi-system entering apparatus 300 according to another implementation of the present disclosure can include but not limited to an input unit 301, a display unit 302, a storage unit 303, and a processor 304. The input unit 301, the display unit 302, and the storage unit 303 are electrically connected to the processor 304.

The input unit 301 is configured for inputting information to the terminal, such as letters. The input unit 301 may be but not limited to a physical keyboard, a touchscreen, or a combination of the physical keyboard and the touchscreen.

The display unit 302 is configured for displaying visual information, such as texts, images. The display unit 302 may be an LED display screen.

The storage unit 303 is configured for storing a plurality of computer-readable program codes 3031. The storage unit 303 can be a read only memory (ROM), a random access memory (RAM), a U-disk, a removable hard disk, and so on.

The processor 304 can include multiple cores for multi-thread or parallel processing.

In this implementation, the processor 304 is configured to execute the plurality of computer-readable program codes 3031 to set unlocking rules of multiple systems; detect matching conditions between a received unlocking password and the unlocking rules of the multiple systems; and enter a corresponding system according to the matching conditions between the received unlocking password and the unlocking rules.

Furthermore, setting the unlocking rules of the multiple systems comprises setting unlocking passwords of the multiple systems.

Furthermore, the unlocking passwords of the multiple systems are set different; and entering a corresponding system according to the matching conditions between the received unlocking password and the unlocking rules comprises: when the received unlocking password matches with the unlocking password of one of the systems, entering the system of which the unlocking password is matched with.

Furthermore, the unlocking passwords of the multiple systems are set identical; setting the unlocking rules of the multiple systems further comprises setting unlocking priority levels of the multiple systems; and entering a corresponding system according to the matching conditions between the received unlocking password and the unlocking rules comprises: when the received unlocking password matches with the set unlocking passwords of the multiple systems, entering the system having the highest unlocking priority level.

Furthermore, the unlocking passwords of the multiple systems are set identical; the unlocking priority levels of the multiple systems are not set, and the unlocking priority level of one of the systems are set by default higher than other systems; and entering a corresponding system according to the matching conditions between the received unlocking password and the unlocking rules comprises: when the received unlocking password matches with the set unlocking passwords of the multiple systems, entering the system having the highest unlocking priority level.

Furthermore, the unlocking modes for the multiple systems are set identical, the unlocking modes being inputting a pattern, a password or a gesture for unlocking.

In the multi-system entering apparatus provided by the implementation, unlocking rules of multiple systems are set, matching conditions between a received unlocking password and the unlocking rules of the multiple systems are determined, and according to the matching conditions between the received unlocking password and the unlocking rules of the multiple systems, a system of which the set unlocking password is matched with by the received password is entered. Therefore, by means of the multi-system entering method provided by the implementation, a user can input an unlocking password of a corresponding system in an unlocking interface according to needs and enter the corresponding system, and thus it is convenient for the user to select the system to be entered, thereby improving user experience.

A terminal is further provided correspondingly by the technical solution. The terminal comprises the multi-system entering apparatus. The terminal may be a dual-system terminal.

It should be understood by persons skilled in the art that all or a part of steps of the above-mentioned implementations may be performed by hardware, or may be performed by programs instructing relevant hardware. The programs may be stored in a computer-readable storage medium which may be a read-only memory (ROM), a magnetic disk, or an optical disc.

Apparently, persons skilled in the art may make various modifications and variations to the present disclosure without departing the spirit and scope of the present disclosure. If these modifications and variations fall within the protection scope of the present disclosure as well as equivalents thereof, the present disclosure is also intended to include these modifications and variations.

What is claimed is:

1. A method for multi-system entering, comprising:
setting unlocking rules of multiple systems;
detecting matching conditions between a received unlocking password and the unlocking rules of the multiple systems; and
entering a corresponding system according to the matching conditions between the received unlocking password and the unlocking rules.

2. The method of claim 1, wherein setting the unlocking rules of the multiple systems comprises:
setting unlocking passwords of the multiple systems.

3. The method of claim 2, wherein
the unlocking passwords of the multiple systems are set different; and
entering the corresponding system according to the matching conditions between the received unlocking password and the unlocking rules comprises:
when the received unlocking password matches with an unlocking password of a first system of the multiple systems, entering the first system.

4. The method of claim 2, wherein the unlocking passwords of the multiple systems are set identical;
setting the unlocking rules of the multiple systems comprises:
setting unlocking priority levels of the multiple systems; and
entering the corresponding system according to the matching conditions between the received unlocking password and the unlocking rules comprises:
when the received unlocking password matches with the set unlocking passwords of the multiple systems, entering a system having the highest unlocking priority level.

5. The method of claim 2, wherein
the unlocking passwords of the multiple systems are set identical;
unlocking priority levels of the multiple systems are not set, and an unlocking priority level of one of the multiple systems are set by default higher than other systems; and
entering the corresponding system according to the matching conditions between the received unlocking password and the unlocking rules comprises:
when the received unlocking password matches with the set unlocking passwords of the multiple systems, entering a system having the highest unlocking priority level.

6. The method of claim 1, wherein unlocking modes for the multiple systems are set identical, and the unlocking modes comprise inputting a pattern, a password, or a gesture for unlocking.

7. An apparatus for multi-system entering, comprising:
a storage unit storing a plurality of computer-readable program codes; and
a processor electrically connected to the storage unit and configured to execute the plurality of computer-readable program codes to:
set unlocking rules of multiple systems;
detect matching conditions between a received unlocking password and the unlocking rules of the multiple systems; and
enter a corresponding system according to the matching conditions between the received unlocking password and the unlocking rules.

8. The apparatus of claim 7, wherein setting the unlocking rules of the multiple systems comprises:
setting unlocking passwords of the multiple systems.

9. The apparatus of claim 8, wherein
the unlocking passwords of the multiple systems are set different; and
entering the corresponding system according to the matching conditions between the received unlocking password and the unlocking rules comprises:
when the received unlocking password matches with an unlocking password of a first system of the multiple systems, entering the first system.

10. The apparatus of claim 8, wherein
the unlocking passwords of the multiple systems are set identical;
setting the unlocking rules of the multiple systems comprises:
setting unlocking priority levels of the multiple systems; and
entering the corresponding system according to the matching conditions between the received unlocking password and the unlocking rules comprises:
when the received unlocking password matches with the set unlocking passwords of the multiple systems, entering a system having the highest unlocking priority level.

11. The apparatus of claim 8, wherein the unlocking passwords of the multiple systems are set identical;
unlocking priority levels of the multiple systems are not set, and an unlocking priority level of one of the multiple systems are set by default higher than other systems; and
entering the corresponding system according to the matching conditions between the received unlocking password and the unlocking rules comprises:
when the received unlocking password matches with the set unlocking passwords of the multiple systems, entering a system having the highest unlocking priority level.

12. The apparatus of claim 7, wherein unlocking modes for the multiple systems are set identical, wherein the unlocking modes comprises inputting a pattern, a password, or a gesture for unlocking.

13. A terminal having multiple systems, wherein the terminal comprises an apparatus for multi-system entering comprising:
a storage unit storing a plurality of computer-readable program codes; and
a processor electrically connected to the storage unit and configured to execute the plurality of computer-readable program codes to:
set unlocking rules of multiple systems;
detect matching conditions between a received unlocking password and the unlocking rules of the multiple systems; and
enter a corresponding system according to the matching conditions between the received unlocking password and the unlocking rules.

14. The terminal of claim 13, wherein setting the unlocking rules of the multiple systems comprises:
setting unlocking passwords of the multiple systems.

15. The terminal of claim 14, wherein
the unlocking passwords of the multiple systems are set different; and
entering the corresponding system according to the matching conditions between the received unlocking password and the unlocking rules comprises:
when the received unlocking password matches with an unlocking password of a first system of the multiple systems, entering the first system.

16. The terminal of claim 14, wherein
the unlocking passwords of the multiple systems are set identical;
setting the unlocking rules of the multiple systems comprises:
setting unlocking priority levels of the multiple systems; and
entering the corresponding system according to the matching conditions between the received unlocking password and the unlocking rules comprises:
when the received unlocking password matches with the set unlocking passwords of the multiple systems, entering a system having the highest unlocking priority level.

17. The terminal of claim 14, wherein
the unlocking passwords of the multiple systems are set identical;
unlocking priority levels of the multiple systems are not set, and an unlocking priority level of one of the multiple systems are set by default higher than other systems; and
entering the corresponding system according to the matching conditions between the received unlocking password and the unlocking rules comprises:
when the received unlocking password matches with the set unlocking passwords of the multiple systems, entering a system having the highest unlocking priority level.

18. The terminal of claim 13, wherein unlocking modes for the multiple systems are set identical, and the unlocking modes comprise inputting a pattern, a password, or a gesture for unlocking.
